(19) United States
(12) Patent Application Publication
(10) Pub. No.: US 2008/0039097 A1
(43) Pub. Date: Feb. 14, 2008

(54) Intelligent IP Services Edge with Dynamic QOS to individually and collectively enhance subscribers quality of experience (QOE) in Wireless Broadband Networks

(76) Inventor: Seshadri Sathyanarayan, (US)

Correspondence Address: Seshadri Sathyanarayan, 60 Waldorf Rd, Newton, MA, 02464, US

(21) Appl. No.: 11/836,052

(22) Filed: Aug. 8, 2007

Related U.S. Application Data
(60) Provisional application No. 60/821,875, filed on Aug. 9, 2006.

(51) Int. Cl. H04Q 7/20

(52) U.S. Cl. 455/442

(57) ABSTRACT

In cellular and broadband wireless networks, specific nodes are assigned to handle functions such as radio resource management (BSC/BTS), session management (PDSN/GGSN/Access Gateways) and service switching (MSC, CSCFs). The function to guarantee Quality of Service, or QOS, is typically associated with the service being implemented and assigned to the one or more nodes implementing the service. There are also policy definition and control nodes (PDFs) identified within the standards. These manage static service level agreements that provide instructions to QOS mechanisms on different nodes within the network. With a move toward an all IP network and a services model with continuously changing requirements (such as user/terminal mobility, varying RF conditions), static QOS mechanisms become inadequate and the need for a dynamic and adaptive QOS mechanism becomes significant.

This application claims the benefit of U.S. provisional application number 60821875, EFSID 1147692, confirmation number 6929, filed on 9 Aug. 2006 at 15:18:07.

### BACKGROUND OF INVENTION

In the field of mobile wireless networks today an increase in the number and type of wireless devices and the availability of higher speed broadband enable new services to be delivered. Content rich media services like voice, video, interactive games, music and multimedia conferencing can be delivered to users wherever they are.

A significant challenge for mobile wireless networks in delivering these new services is to manage the quality of the services. Users within the range of a wireless antenna share the radio resources of that antenna. The quality of services delivered to these users on their wireless devices is affected by their Radio Frequency (RF) conditions that vary randomly with their mobility and the activity of other users who share the same antenna sector.

IP Service delivery in wired networks is managed by a network element called the Broadband Remote Access Server (or BRAS). Wireless networks also employ a similar element called the Access Services Network gateway or (ASN gateway). Other variations of this element include a Gateway GPRS Serving Node (GGSN) and Packet Data Services Node (PDSN). These elements are designed to terminate and manage user sessions. However, the user perception of the network performance is primarily determined by the experience of their high value or mission critical applications. User sessions comprise of different application services. None of these network elements adequately address the issue of QOS at the individual application service level given the problems of user mobility and bandwidth variations.

### BRIEF SUMMARY OF INVENTION

The WiLabs Intelligent Services Edge or WiSE, is a new network element, that is deployed at the border between the radio access and transport networks that implements a dynamic Quality of Service mechanism to deliver predictable application service performance. The WiSE network element builds a new view of users and application services within the range of each antenna and uses this view to collectively and actively manage the services being delivered to the users.

### DETAILED DESCRIPTION

This application claims the benefit of U.S. provisional application number 60821875, EFSID 1147692, confirmation number 6929, filed on 9 Aug. 2006 at 15:18:07.

In the following detailed description of embodiments of the invention, reference is made to the accompanying drawing which forms a part hereof, and in which is shown by way of illustration specific preferred embodiments in which the subject matter may be practiced. These embodiments are described in sufficient detail to enable those skilled in the art to practice them, and it is to be understood that other embodiments may be utilized logical, mechanical, and electrical changes may be made without departing form the spirit and scope of the subject matter. Such embodiments of the inventive subject matter may be referred to, individually and/or collectively herein by the term “invention” merely for convenience and without intending to voluntarily limit the scope of this application to any single invention or inventive concept if more than one is in fact disclosed. The following detailed description is, therefore, not to be taken in a limiting sense, and the scope of embodiments of the present invention is defined only by the appended claims.

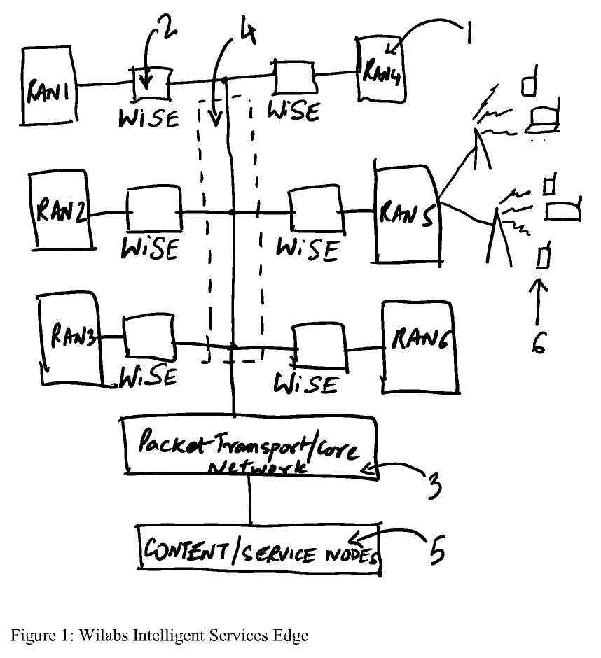

FIG. 1 illustrates a typical mobile wireless access network with multiple Radio Access Networks (RANs) 1. These are connected to a packet transport/core network 3. The network element WiSE 2 resides at the border between the transport/core network 3 and the RANs 1. A logical mesh of WiSE network elements 4 is also depicted in FIG. 1. The transport/core network 3 comprises of content and service network elements 5 that deliver voice, video, music, interactive games and other such services to users with mobile wireless devices 6 connected to RANs 1.

The WiSE network elements 2 intercept, inspect and capture information about the services and the content being delivered by the content and service network elements 5. Information about the users, the wireless device 6 being used by them to receive the service is also collected as needed by the WiSE network elements 2 by requesting such information from the appropriate content and service network elements 5 that store them. Information gathered in this manner is used to build a new perspective of users and the services being delivered to them within each RAN 1.

The new perspective built by the WiSE network elements 2 is kept up to date continuously with the actions described in [009].

The new perspective built by the WiSE network elements 2 is used to trigger changes to the services and the content being delivered to the users with wireless devices 6 by triggering the content and service network elements 5. Information captured by the WiSE network elements 2 is also shared with the content and service network elements 5 as needed.

The new perspective built by the WiSE network elements 2 is also made available to all the WiSE network elements within the WiSE network elements mesh 4 as needed. As the mobile user and the wireless device 6 receiving the service move from one RAN 1 to another RAN 1 (e.g. RAN 5 to RAN 6 in the FIG. 1), the WiSE network element 2 in the new RAN 1 is able to access information on the user, the wireless device and the services that were being delivered before the user and the wireless device moved.

The exchange of information described in [011] is then used to further improve the perspective built by the WiSE network elements 2.

The new perspective built by WiSE network elements 2 is used to admit/deny new services and or users and wireless devices based on the availability of resources to support them.

The new perspective built by WiSE network elements 2 is also used to improve the routing and efficiency of content and services delivered to the users with wireless devices 6.

This application claims the benefit of U.S. provisional application number 60821875, EFSID 1147692, confirmation number 6929, filed on 9 Aug. 2006 at 15:18:07.

What is claimed is:

1. A new network element WiLabs Intelligent Services Edge (WiSE) that resides at the border of transport and radio access networks within mobile wireless networks.

2. The new network element in claim 1 wherein it collects and builds an instantaneous individual user and aggregate application usage view with associated QOS requirement attribute-values for each wireless user, application and device at a given location. This is called a QOS context map. The QOS context map can be at an antenna cell, sector or radio access network level. The QOS requirements are based on (but not limited to) current RF conditions (including signal to noise or S/N ratios etc.), the current user set to antenna sector association, device conditions (including battery state, applications running or available, network interfaces, display resolution, interaction characteristics—key pad, stylus based), user's current location (geographic—GPS based, cell tower location and/or network—Internet Protocol or IP based), user's static subscriber and current application usage profiles at a given location (from existing nodes or deduced from the current session), and currently supported active content or service flows.

3. The new network element in claim 1 wherein it builds a new mapping of wireless user and device sessions based on IP flow priorities that are dynamic and continuously adjusted to the changing RF conditions to meet the negotiated Service Level Agreement (SLA) or QOS requirements in claim 2. This uses any existing configured user policies to dynamically re-negotiate the sessions (with multiple IP flows) taking into account the bandwidth available to each user and the aggregate bandwidth possible at that given point in time.

4. The new network element in claim 1 wherein it dynamically transfers the QOS context map to “best-fit” the user application requirements to the current RF conditions as the wireless user or device connected to the network moves to a new location or network connection point.

5. The new network element in claim 1 where in it maintains a shared state of the global QOS map of all connected WiSE elements within a network.

6. The new network element in claim 1 wherein it intercepts, inspects and deduces wireless user and device session and service flow characteristics such as type of service, service flow rate in either direction, available bandwidth, allocated bandwidth. In addition, combined with the information in QOS context maps described in claim 2, it deduces the type of the RF connection, the current downlink and uplink S/N conditions.

7. The new network element in claim 1 wherein it comprises the ability to use the configured user profile to trigger wireless users and devices to switch their connections to a more appropriate type or location based on the QOS context maps described in claim 2, and the currently available network resources. The network element may load balance multiple users by triggering “soft” hand-offs across antenna sectors or Base Stations.

8. The new network element in claim 1 wherein it can proxy trigger a re-negotiation of session parameters between wireless users or devices and content or service hosts. The renegotiation can be automatically triggered based on changes in user RF conditions, mobility of the specific user or other users in and out of the shared antenna sector.

9. The new network element in claim 1 wherein it makes the QOS context maps persistent and re-usable across user or wireless device sessions.

10. The new network element in claim 1 wherein a network of such elements exchanges the QOS context maps as needed in real-time via the mesh configuration between the nodes. The network element in claim 1 may pre-share the QoS context maps across adjacent nodes to dramatically improve the session hand-off time.

11. The new network element in claim 1 wherein it relays needed QOS information from the context maps to service and content hosts upon request using a standard interface and protocol.

12. The new network element in claim 1 wherein the intelligence developed with the information gathered in claim 2 and claim 3 is used to improve the routing of existing and new services. One embodiment of such improvement includes the ability to locally route or intelligently turn around at the WiSE network element, services between users and/or wireless devices that are within the same RAN.

13. The new network element in claim 1 wherein the intelligence developed with the information gathered in claim 2 and claim 3 is used to deliver user and location specific content and services to users with wireless devices.

14. The new network element in claim 1 wherein it delivers an enhanced Quality of Experience (QOE) with dynamic session negotiation in the context of aggregate cell or sector usage and user application service privileges.

15. The new network element in claim 1 wherein the intelligence developed with the information gathered in claim 2 and claim 3 is used to trigger a handoff of one or more users from one antenna sector to another or one Base Station to another to balance the load on the network.

16. The new network element in claim 1 wherein its capabilities are employed in wireline, cable, satellite or other non-wireless networks to improve the quality of experience of users and devices in these networks.
